(19) United States
(12) Patent Application Publication
(10) Pub. No.: US 2008/0265052 A1
(43) Pub. Date: Oct. 30, 2008

(54) Method of using an ultrasonic spray apparatus to coat a substrate

(76) Inventors: Ke-Ming Quan, West Chester, OH (US); Gary James Dechert, Fairfield, OH (US); LuFang Wen, Mason, OH (US); Lowen Robert Morrison, Cincinnati, OH (US); Ronald Edward Pegoli, Cincinnati, OH (US); Stephen Robert Glassmeyer, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/080,395

(22) Filed: Apr. 2, 2008

Related U.S. Application Data
(60) Provisional application No. 60/926,891, filed on Apr. 30, 2007.

(51) Int. Cl. B05B 17/04

(52) U.S. Cl. 239/4

(57) ABSTRACT

A method to eject a fluid from a surface. The steps of the method are i.) vibrating a surface of a nozzle in a direction substantially normal to the surface and ii.) providing an amplitude of the vibration that is equal to or greater than about 120 microns.

### CROSS REFERENCE TO RELATED APPLICATIONS

This application claims priority to and the benefit of U.S. Provisional application 60/926,891, filed on Apr. 30, 2007, which is hereby incorporated by reference herein in its entirety.

### FIELD OF THE INVENTION

This invention relates to a method of applying a fluid to a substrate using an ultrasonic spray device.

### BACKGROUND OF THE INVENTION

A wide variety of operations, especially food processing, involve the application of a fluid coating material. Conventionally, the fluid coating solution or slurry is applied to the food substrate with conventional spray nozzles that dispense the slurry in a spray pattern using only the hydrostatic pressure of the slurry supply to form the spray. While useful and effective, the ease of conventional hydrostatic slurry restrictive orifice discharge nozzles has numerous disadvantages.

One disadvantage involves the difficulty of applying low flow rates, especially below 500 ml/min. The conventional hydrostatic pressurized nozzle is known to have difficulty maintaining a good spray pattern at an accurate flow rate. These low flow rates are often required for fluid additives to the food substrate, especially when applying expensive or highly functional materials.

Another disadvantage involves the difficulty of spraying slurry of large particle sizes. This is because the orifice size for the conventional hydrostatic pressurized nozzle is typically below 500 μm in diameter. Nozzle clogging is known to be one of the major drawbacks of slurry applications.

Yet another disadvantage involves the gradual build-up of the slurry upon the interior of the nozzle. After this build-up, the nozzle must be thoroughly cleaned. Depending upon a variety of factors, the cleaning operation must be conducted at least once per day and perhaps as frequently as once per operating shift. Cleaning the nozzle is thus a standard element of operating hygiene that usually takes up to an hour to perform. Thus, slurry build-up requires the direct cost of maintenance servicing. More importantly, since most processing lines are generally continuous, slurry build-up can cause more significant cost of downtime of the entire processing line.

Still another problem resides in the momentum of spray from the conventional hydrostatic pressurized nozzle, which can reach a speed over fifty meters per second. Such a momentum of the spray, if closely coupled with the food product, can be destructive to the shape and texture of the product. It may also disorientate the packing arrangement of the product on the process line. These limitations place restrictions on the potential location of the nozzle relative to the product stream.

Still another problem resides in the large amount of expensive ingredients lost due to overspray. The conventional nozzle is known to have large droplet size distribution which makes it difficult to contain the spray in a small targeted area. The large droplet size distribution means a significant amount of extremely fine droplets may be generated. These fines droplets do not have sufficient mass and are often lost to the surrounding environment. Further, these fines droplets can pose potential health risks due to inhalation.

Surprisingly, the ultrasonic method provides dramatic improvements in the fluid coating of food substrates.

### SUMMARY OF THE INVENTION

The present invention is a method to eject a fluid from a surface, comprising the steps of:

a. vibrating a surface of a nozzle in a direction substantially normal to the surface and

b. providing an amplitude of the vibration is equal to or greater than about 120 microns.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 is a side view of the ultrasonic apparatus arrangement;

FIG. 2 is a schematic diagram of the ultrasonic apparatus arrangement; and

FIG. 3 is a perspective view with a portion broken away and portion shown schematically of the apparatus and system of this invention.

FIG. 4 is a plan view of the spray patterns.

FIG. 5 is a graphical representation of the power input to nozzle over time.

The figures herein are not necessarily drawn to scale.

### DETAILED DESCRIPTION OF THE INVENTION

Section I. will provide terms which will assist the reader in best understanding the features of the invention, but not to introduce limitations in the terms inconsistent with the context in which they are used in this specification. These definitions are not intended to be limiting. Section II. will discuss the present invention.

### I. TERMS

As used herein, “amplitude” is referred to as the vibration displacement of the nozzle tip. The displacement is measured from peak-to-peak.

As used herein, “edible substrate” or “substrate” includes any material suitable for consumption that is capable of having a fluid disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, cakes, chewing gum, candy, bread, fruit, dried fruit, beef jerky, crackers, pasta, hot dogs, sliced meats, cheese, pancakes, waffles, dried fruit film, breakfast cereals, toaster pastries, ice cream cones, ice cream, gelatin, ice cream sandwiches, ice pops, yoghurt, desserts, cheese cake, pies, cup cakes, English muffins, pizza, pies, meat patties, and fish sticks.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., gelatin, yoghurt).

In addition, the edible substrate can include pet foods such as, but not limited to, dog biscuits and dog treats.

In a preferred embodiment, the substrate is a fried fabricated snack chip. The fluid can be disposed upon the snack chip by any suitable means. For instance, the fluid can be disposed on the chip dough before the dough is fried to make the fried fabricated snack chip, or the fluid can be disposed on the chip after it has been fried.

In one embodiment, the fabricated snack chip is a fabricated potato crisp, such as that described by Lodge in U.S. Pat. No. 5,464,643, and Villagran et al. in U.S. Pat. No. 6,066,353 and U.S. Pat. No. 5,464,642.

As used herein, the term “coating” refers to a thin film.

As used herein, the term “critical power” refers to the minimum power level sufficient to eject the liquid from the nozzle.

As used herein, the term “fluid” refers to a homogeneous liquid; slurry and flowable paste; and powder.

As used herein, the term “piezoelectric effect” is the ability of crystals and certain ceramic materials to generate a voltage in response to applied mechanical stress. The piezoelectric effect is reversible in that piezoelectric crystals, when subjected to an externally applied voltage, can change shape by a small amount. The effect finds useful applications such as the production and detection of sound. As used herein, the term “piezoelectric transducer” refers to the actuators and sensors built with the piezoelectric materials.

As used herein, the term “magnetostriction” is a property of ferromagnetic materials that causes them to change their shape when subjected to a magnetic field. Magnetostrictive materials can convert magnetic energy into kinetic energy, or the reverse. The actuators and sensors built with the magnetostrictive materials are magnetostrictive transducers. As used herein, the term “magnetostrictive transducer” refers to the actuators and sensors built with the magnetostrictive materials.

As used herein, the term “registered pulse” refers to modulating the power level of the converter to pulse the spray coming out of the vibrating nozzle to coincide with an event in time.

As used herein, the term “solids” refers to particles that are not in dissolved in the fluid.

As used herein, the term “viscosity modifiers” refers to materials that change the viscosity of the fluid or enhance the ability of the fluid to suspend other materials.

As used herein, the term “structurants” refers to materials that change the viscosity of the fluid or enhance the ability of the fluid to suspend other materials by imparting a shear thinning viscosity.

As used herein, the term “substantially normal to the surface” refers to a nozzle which is substantially perpendicular to the surface.

### II. PRESENT INVENTION

The ultrasonic apparatus of the present invention offers multiple benefits based on the accurate delivery of materials (e.g., salt, seasoning, flavors, vitamins, nutrients, or other particulates) to substrates such as chips, including the ability to accurately control the flavor intensity and/or flavor type from one substrate to the next in an arrangement of these substrates. Furthermore, the ultrasonic apparatus provides accurate delivery of a given amount and accurate targeting of a substrate such that only a precise area of the substrate receives the additive materials. This can be helpful in the application of salt, where, for example, a more precise application can enable lower sodium level declarations in an ingredient label. In addition, the ultrasonic apparatus provides the additional advantages of cost reduction by avoidance of application of expensive additive materials outside of the substrate that would otherwise be lost, having, in turn, the added advantage of minimizing or eliminating the need to create a recycle stream of the material being applied.

Moreover, the ultrasonic apparatus of the present invention offers multiple process benefits such as
a. quick changeovers from one flavor/strength to another on the same production line which significantly reduces the manufacturing down time;
b. the ability to “pulse” the addition of additive materials accurately which enables incremental gains in manufacturing flexibility and efficiency since particulates can now be added in process areas from which a recycle stream is captured without fear of adding the additive materials to that recycle stream (e.g., unused dough post cutting of dough pieces, excess oil from chip drainage post frying, etc.,);
c. pulsed delivery of fluids or slurries which allow for multiple nozzles to be placed in series, delivering multiple benefits to a single stream of products (e.g., alternating substrates or chips (or groups of them) may be seasoned with different flavors to avoid sensory satiety);
d. easily adjusting the ultrasonic spraying amount to match changing line speed which offers flexibility to change the flow rate without negative impact to the spray property;
e. the capability of allowing application of slurry with solid particles of much larger size without the concern of clogging because the ultrasonic nozzle typically has an orifice of several magnitudes larger in diameter than a conventional spray head, since the spray by ultrasound is not created by the kinetic energy of a pressurized jet fluid going through the small orifice of a spray nozzle;
f. the ability to minimize the force of impact of the spray on the substrate because the ultrasound spray is not created by pressure and it sprays in a gentle fashion;
g. the ability to locate nozzles in diverse locations and precisely target specific substrate elements which allows for a product stream with custom and/or discontinuous benefits; and
h. when coupled with an accurate pump/metering device, delivery of uniform distribution of specialized coating (e.g., nutrient addition, medicinal compounds, etc.) is possible without variability concerns between sections of substrate.

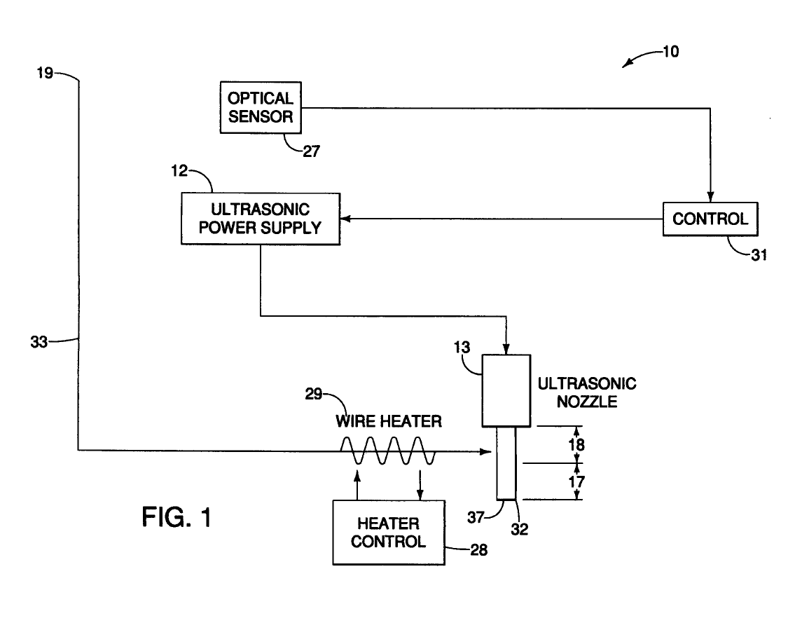

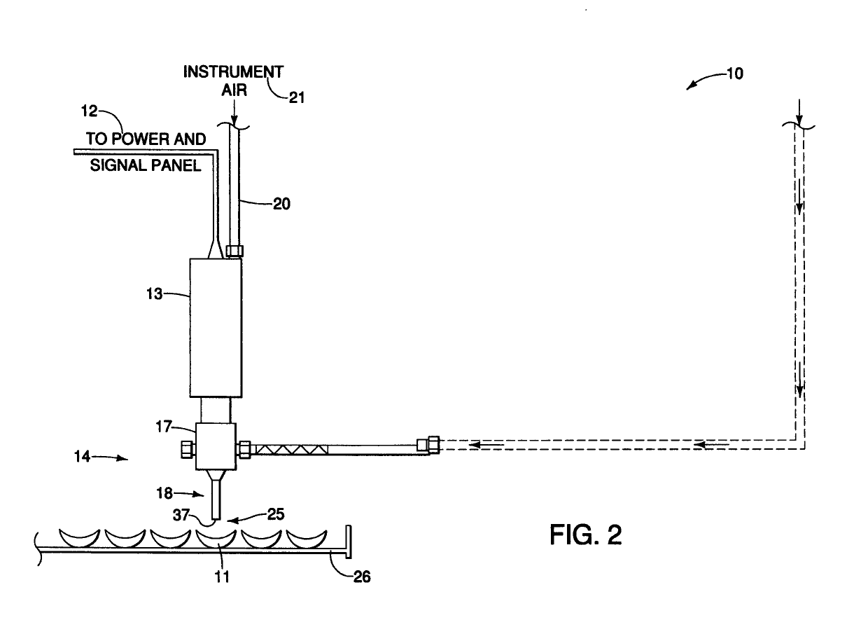

Referring to FIG. 1, substrates 11 (shown in FIG. 2), such as snack chips, are flavored according to the method as explained in Section B. discussed below using the ultrasonic apparatus 10 shown schematically in FIG. 1. First, power is supplied to the control 31, ultrasonic power supply 12, heating element 29 (optional to high viscosity fluids), and the metering pump (not shown).

As shown in FIG. 1, the power is controlled by the heating control 28 to feed power to a heating block 29 located inside an insulated chamber (not shown). The heating block 29 may comprise electrical resistance heaters (not shown), the temperature of which is controlled by a heating control 28. The heating block 29 may be used to heat the fluid 19 above its critical temperature to facilitate application of the fluid 19 to the substrate 11 (FIG. 2), such as a fried corn flavor.

Second, the control 31 is set to have
a. the low and high pulse voltage settings;
b. the pulse width (the duration of the pulse at the high amplitude);
c. the delay time (time between detecting the signal from the optical sensor 27 to sending the high voltage pulse to the ultrasonic power supply 12);
d. the required temperature for the heating element 28 (optional to high viscosity fluids); and
e. the required flow rate for the metering pump (not shown).

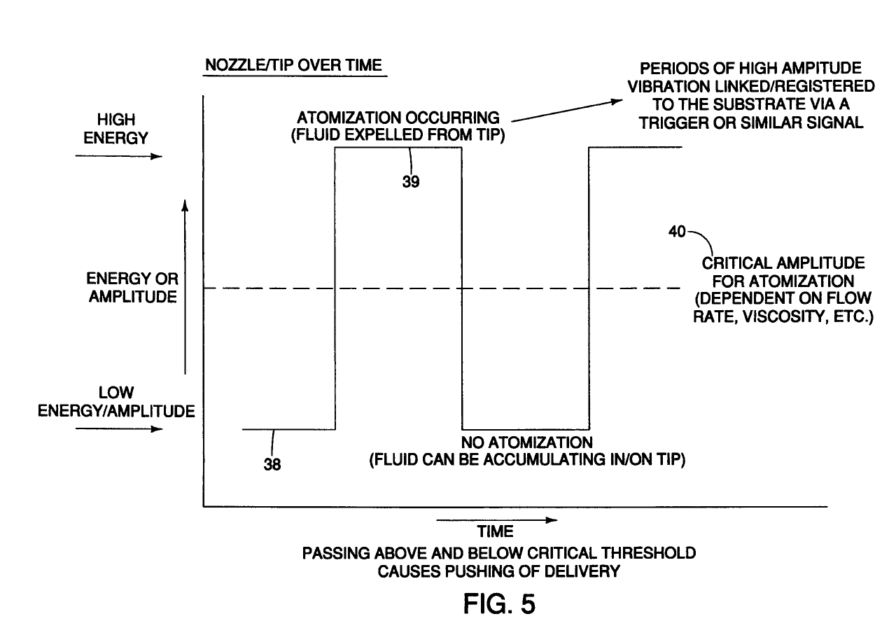

As shown in FIG. 1, third, the control 31 starts the pump and the ultrasonic nozzle 14. The ultrasonic nozzle 14 vibrates at a low amplitude 38 (shown in FIG. 5) determined by the low voltage from the control 31. As soon as the optical sensor 27 detects a substrate (not shown), it sends out a signal to the control 31. The control 31 in turn sends out a pulse at high voltage, at a preset delay time and a preset pulse width. In response to the pulse of high voltage from the control 31, the ultrasonic power supply 12 increases its driving voltage supplied to the ultrasonic converter 13, which, because of its piezoelectric nature, converts this high driving voltage into high vibration amplitude. This increased mechanical vibration amplitude is transmitted mechanically through a good acoustic coupling to the ultrasonic nozzle 14. Net, the short pulse of high voltage from the control unit is eventually converted into a brief period of mechanical vibrations at high amplitude 39 (shown in FIG. 5). The choice of the high and low amplitudes is such that atomization only occurs at the high amplitude 39 (shown in FIG. 5). The choice of delay time ensures that atomization is timed correctly for each passing substrate (not shown). The choice of the pulse width ensures that the spray is intercepted by the length of the substrate (not shown) without overspray.

The optical sensor 27 senses the substrate 11 (not shown) and signals to the control 31. The control 31 is programmed to determine the pulse amplitude, pulse width, and delay time. The liquid 19 is fed into the ultrasonic nozzle 14 whereby the liquid is atomized by the ultrasonic process.

In one embodiment, a plurality of vibrating nozzles 14 may be used to spray a baked snack product with an atomized mist while it is being conveyed on a continuous belt in a hooded, cooling conveyor.

In another embodiment, the fluid 19 may be applied via a set of vibrating nozzles 14 located in series and/or in parallel. Vibrating nozzles 14 in series deliver the capability to add variety of coating benefits in the direction of the machine or the capability to deliver increased levels of the fluid 19. Vibrating nozzles 14 in parallel allow for multiple lanes of product coating, or for potentially even coating of an entire substrate, like for example, coating of the dough sheet with a coating to modify how the behavior of the dough sheet upon cooking, to modify texture, fat absorption, or to flavor the product.

In another embodiment, the spray may be applied in a continuous mode where the high and low voltage settings in the control are set to be the same value.

Referring to FIG. 2, the ultrasonic apparatus 10 for coating a substrate 11 includes a power supply 12, a converter 13, and a vibrating nozzle 14.

Below will detail each component of the ultrasonic apparatus 10.

i. Power Supply

Referring to FIG. 1, the ultrasonic apparatus 10 comprises a power supply 12 that furnishes electrical energy through a cable to a converter 13 wherein high frequency (typically from about 20 kHz to about 200 kHz) electrical energy is converted into vibratory mechanical motion for example by a piezoelectric converter device.

The power supplied to the ultrasonic apparatus 10 may be varied during the process of the present invention.

For ultrasonic atomization, power levels are generally under 15 watts. Power is controlled by adjusting the output level on the power supply 12.

The exact magnitude of power required depends on several factors. These include nozzle type; operating frequency; fluid characteristics (e.g., viscosity, solids content); and flow rate.

Nozzle Type and Operating Frequency

Each nozzle type, because of its specific geometry and other factors, will generally have a different critical power level for the same fluid. For example, the critical power level of a 48 kHz nozzle, designed with a conical atomizing surface to deliver a wide spray pattern at substantial flow rates, will generally be in the neighborhood of from about 3.5 to about 4 watts of input power when atomizing water. Another nozzle, operating at the same frequency, but designed for microflow operation (a very small atomizing surface), may require only about 2 watts to atomize water.

The type of fluid being atomized strongly influences the minimum power level. More viscous fluids or fluids with high solids content generally increase the minimum power requirement. For example, the 48 kHz nozzle with a conical atomizing surface mentioned in the last paragraph, might require at least 8 watts of input power if the fluid being atomized were a 20% solids-content, isopropanol based material.

Fluid Characteristics

Section iv. titled Fluid (see below) provides further information on fluids which are good candidates for ultrasonic atomization.

Flow Rate

The flow rate also plays a role in determining minimum power level. For a given nozzle, the higher the flow rate, the higher will be the power required, since the nozzle is working harder at higher flow rates. The vibrating nozzle 14 can cover a wide range of flow rates, from a few microliters/min to as much as over about 350 ml/min. As a result of our observations, the maximum flow velocity that still allows for proper atomization or critical flow velocity is on the order of from about 30 cm/sec. As an example, for a vibrating nozzle 14 with an orifice diameter of 2.5 mm this translates into a maximum flow rate of from about 88 ml/min, assuming continuous spray. The flow rate range of a specific nozzle is governed by the following factors: power supply, operating frequency, orifice size, atomizing surface area, and fluid characteristics.

Referring to FIG. 2, orifice 37 size plays a principal role in determining both maximum and minimum flow rates. The maximum flow rate is related to the velocity of the fluid stream as it emerges onto the atomizing surface. The atomization process relies on the fluid stream spreading out onto this surface and creating capillary waves. At low stream velocity, surface forces are sufficiently strong to “attract” the fluid, and cause it to cling to the surface. As the velocity of the stream increases, the critical velocity is reached where the surface forces are overcome by the kinetic energy of the stream, causing the stream to become totally detached from the surface.

In theory, there is no lower flow rate limit for any orifice 37 size since the process is independent of pressure. However, in practical terms, lower limits do exist. As the flow is reduced, a point is reached where the velocity becomes so low that the fluid emerges onto the atomizing surface in a non-uniform circumferential manner, causing the atomization pattern to become distorted. In some applications, where stable spray patterns are unimportant (e.g., some chemical reaction chambers), this distortion may be tolerable. In other applications, where the integrity of the pattern is vital (e.g., surface coatings), the low-velocity stream distortions are unacceptable. As a practical matter in such cases, the minimum velocity of the stream from an orifice 37 of a given size is about 20% that of the maximum velocity. For our example above, where the maximum flow rate is 88 ml/min, the minimum flow rate is approximately 18 ml/min.

The amount of atomizing surface area available is the final factor influencing the maximum flow rate available from a given nozzle. An atomizing surface of a given size obviously has a limitation as to how much fluid it can support and still create the film that is required to create capillary waves. If the quantity “dumped” onto the surface becomes too great, it overwhelms the capability of the surface to sustain the fluid film.

The last factor, fluid characteristics, has been covered in the section under Fluids. The more difficult a fluid is to atomize, the lower will be its maximum flow rate for a given nozzle.

Maximum sustainable flow rate not only depends on the surface area of the tip of the nozzle but also on the vibrating nozzle's 14 operating frequency. Lower frequency nozzles can support greater flow rates than higher frequency nozzles having the same atomizing surface area.

In summary, there are a number of factors that can determine maximum flow rate for a given nozzle. However, in every instance, only one of these factors will set the limit. If we are dealing with a hard-to-atomize material, for example, it is likely that the maximum flow rate will not depend on orifice 37 size nor available surface area, but solely upon the atomizability of the fluid. Similarly, if we have a vibrating nozzle 14 with an orifice 37 whose capacity exceeds that of the available atomizing surface area, the surface area becomes the limiting factor. This interplay among the limiting factors is important in specifying a vibrating nozzle 14 for a given application.

ii. Converter

Referring to FIG. 1, as stated above, the output of the converter 13 can be amplified, in what is termed a booster assembly 15 (not shown). However, a choice design of the vibrating nozzle 14 can generate sufficient amplitude gain, eliminating the need of a separate booster assembly. Generally, any kind of converter may be used. In one embodiment, a piezoelectric lead zirconate titanate crystals (“PZT”) converter may be used. An example of such converter is VibraCell Model CV 33, manufactured by Sonics & Materials, INC, based in Newtown, Conn. 06470, USA. The amplitude of the vibration of the converter 13 can be set on the power supply. For example, at a full amplitude setting, a 20 kHz converter provides 20 μm vibration amplitude.

iii. Vibrating Nozzle

Referring now to FIG. 1, there is shown a first embodiment of the present nozzle 14 generally referred to by reference numeral 14. The vibrating nozzle 14 includes a first end 17 and a second end 18. The first end 17 of the vibrating nozzle 14 connects to the converter 13. The second end 18 of the nozzle 14 provides an exit for fluid 19 whereby the fluid 19 exiting from nozzle 14 is finely atomized and in effect sprayed in the form of a mist or light rain onto the substrates 11. The second end 18 comprises the vibrating nozzle tip 32. The nozzle tip 32 comprises an orifice 37. The orifice 37 has a circumference 42. The circumference 42 can be from about 0.1 cm to about 1.0 cm. As their name implies, vibrating nozzles employ high frequency sound waves, those beyond the range of human hearing.

Disc-shaped ceramic piezoelectric converters 13 convert electrical energy into mechanical energy. The converters 13 receive electrical input in the form of a high frequency signal from a power supply 12 and convert that into vibratory motion at the same frequency.

Vibrating nozzles 14 are configured such that excitation of the piezoelectric crystals (not shown) creates a transverse standing wave along the length of the vibrating nozzle 14. The ultrasonic energy originating from the crystals (not shown) located in the large diameter of the vibrating nozzle 14 undergoes a step transition and amplification as the standing wave as it traverses the length of the vibrating nozzle 14.

Referring to FIG. 2, the vibrating nozzle 14 is designed such that a nodal plane is located between the crystals (not shown). For ultrasonic energy to be effective for atomization, the atomizing surface (vibrating nozzle tip 32) must be located at an anti-node which is where the vibration amplitude is greatest. To accomplish this the vibrating nozzle's 14 length must be a multiple of a half-wavelength. Since wavelength is dependent upon operating frequency, vibrating nozzle 14 dimensions are governed by frequency. In general, high frequency vibrating nozzles 14 are smaller, create smaller drops, and consequently have smaller maximum flow capacity than vibrating nozzles 14 that operate at lower frequencies.

Referring to FIG. 1, fluid 19 introduced onto the atomizing surface through a large, non-clogging feed tube 33 running the length of the vibrating nozzle 14 absorbs some of the vibrational energy, setting up wave motion in the fluid 19 on the surface. For the fluid 19 to atomize, the vibrational amplitude of the atomizing surface must be carefully controlled. Below the so-called critical amplitude, the energy is insufficient to produce atomized drops. If the amplitude is excessively high, the fluid 19 is literally ripped apart, and large “chunks” of fluid 19 are ejected, a condition known as cavitation. Only within a narrow band of input power is the amplitude ideal for producing the vibrating nozzle's 14 characteristic fine, low velocity mist.

In coating applications, the unpressurized, low-velocity spray significantly reduces the amount of overspray since the drops tend to settle on the substrate 11, rather than bouncing off it. This translates into substantial material savings and reduction in emissions into the environment. In addition, the spray can be controlled and shaped precisely by entraining the slow-moving spray in an ancillary air stream.

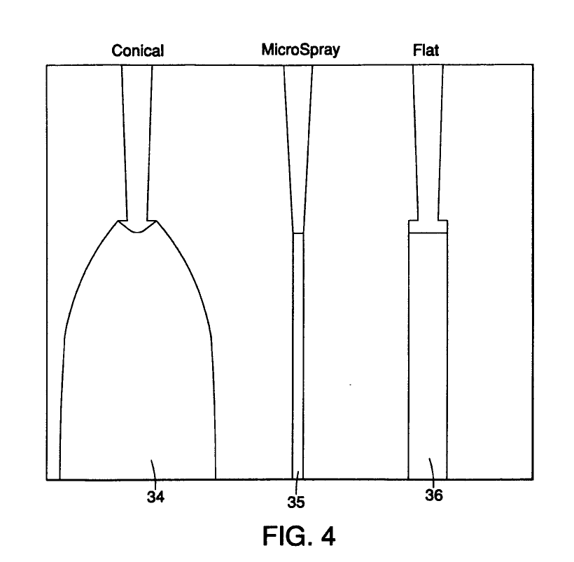

Spray patterns from as small as about 2 mm wide to as much as 30-60 cm wide can be generated. Referring to FIG. 4, different possible spray patterns are shown. Depending on the width requirements of the spray pattern and the required flow rate, the atomizing surface may have a very small diameter or an extended, flat section 36. For example, the vibrating nozzle 14 can have a cone-shaped spray pattern 34 resulting from the conically shaped atomizing surface. Typically, spray envelope diameters from about 50 mm to about 80 mm can be achieved. Another example is a microspray pattern 35 which has an orifice 37 size range from 0.38-1.1 mm. This spray pattern is usually recommended for use in applications where flow rates are very low and narrow spray patterns are needed.

The vibrating nozzle 14 can be fabricated from titanium because of its good acoustical properties, high tensile strength, and excellent corrosion resistance.

Specifically, in the preferred embodiment, the vibrating nozzle 14 can be of any shape. In one embodiment, the vibrating nozzle is cylindrical.

The vibrating nozzle of this invention can be made of any material known by one of ordinary skill in the art capable of holding compositions in place for an indefinite period of time. While soft or nonrigid materials can be used; materials rigid enough to sit in a substantially upright position are preferred. Such materials include, but are not limited to, metals such as aluminum, stainless steel, and titanium; diamonds; and combinations thereof.

iv. Fluid

Referring to FIG. 2, the fluid 19 is supplied with a positive displacement (hereinafter “PD”) pump where the total flow rate is adjusted accurately by pump RPM. The use of a PD pump is advantageous by eliminating the dependence of the flow rate on such factors as fluid viscosity, concentration of flavoring ingredients in the fluid, and throughput of product being flavored.

Snack food-flavoring fluid of any suitable viscosity which is capable of dispersion into fine droplets can be used with the present invention. As nonlimiting examples, fluid 19 having viscosities at 110 degree F. of from about 1 centipoise to over 560 centipoise have been used with this invention.

The desired flow rate of the fluid 19 for a single vibrating nozzle 14 may vary depending upon the concentration of flavoring ingredients in the fluid, the throughput of the product being flavored, the desired flavor intensity of the final product, and the like. As non-limiting examples, for a single vibrating nozzle 14 flow rates of up to 300 ml/min have been used with this invention.

The physical nature of a fluid 19 plays a central role in the ultimate success of any atomization process. Factors such as viscosity, solids content, miscibility of components, and the specific rheological behavior of a fluid affect the outcome.

The present invention can be used with a fluid containing a carrier or mixture of carriers (e.g., oil, propylene glycol, and water) and functional compounds comprising flavors, sugar, spices, and mouthfeel agents (e.g., lecithin, glycerin) as well as a fluid modifier (e.g., maltodextrin, carboxylmethyl cellulose) to the desired taste purpose and processability. The fluid characteristic is defined as a free flowable liquid, or slurry or paste with viscosity range of from about 1 to about 500 cps, solid content less than about 45% and particle size smaller than about 185 um, more preferably to less than about 100 um, most preferably to smaller than about 50 um.

v. Process Mode

Referring to FIG. 2, the ultrasonic apparatus 10 is typically operated in a continuous mode. However, the ultrasonic apparatus 10 can also be operated with a pulsed spray or a registered spray.

a. Pulsed Spray

Pulsed ultrasonic atomization can be achieved by operating the ultrasonic power on and off at a low repetition rate, e.g., one pulse every few seconds. In order to deliver a coating to each substrate in a sequence of fast moving substrates, and not the gap in between substrates, the spray needs to be pulsed, and the pulse needs to be accurately controlled with a start timing and a duration.

Referring to FIG. 2, the fluid 19 is supplied at a constant flow rate. The pulsed spray is achieved by modulating the amplitude of the power supply 12 from about 20 kHz, while keeping the ultrasonic power 12 on all the time. The high and low amplitudes are selected so that atomization occurs only during the high amplitude. Since the fluid 19 is supplied at a constant flow rate, at the low amplitude where the fluid 19 is not atomized, it wets the orifice 37 of the vibrating nozzle 14 by the capillary force, waiting for the arrival of the high amplitude to atomize. The duration of the high amplitude (the pulse width) is determined so that there is no overspray over the length of the substrate 11 (FIG. 1) or chip. In theory the duration should be smaller than the time the substrate 11 is under the vibrating nozzle, or substrate length divided by the speed of the substrate 11. In reality, because of the nature of electro-mechanical response and the viscosity of the medium, shorter pulse duration is needed. The timing of the pulse is triggered by an optical sensor 27 (shown in FIG. 1).

Another embodiment to achieve pulsed spray is to pulse the fluid by for example using a pump which moves the fluid in a pulsed motion. The rate of the pulse may be adjusted by pump RPM.

In yet another embodiment, pressurized air can be injected into the fluid pipe intermittently, which segments the fluid periodically with a small volume of air pockets. The pulsed spray is then achieved by the discontinuity created by the air pockets.

In yet another embodiment, a mechanical deflection can be employed to periodically deflect/catch/recycle the stream to avoid deposition of the material in unwanted regions.

b. Registered Spray

The combination of pulsed ultrasonic spray with choice of control logic can provide new processing flexibility that enables new product offerings. In one non-limiting example, two vibrating nozzles 14 are on the same row, each dispensing a different seasoning, e.g., the following are some of the possible product variations where x represents a chip and y represents a chip.
i. alternating flavor by every chip, e.g., x, y, x, y;
ii. alternating flavor by a number of chips, e.g., x, x, x, y, y, y;
iii. having different frequencies of x vs. y, e.g., x, y, y, y . . . , or x, x, x, y;
iv. having x and y on the same chip of either the same or different intensities, xy, Xy, xY;
v. having x and y on the same chip but different locations, e.g., x in the first half and y in the second half;
vi. any combination of above; and
vii. any number of flavors, not limited to two.
   Other variations of substrates are described in currently pending, commonly assigned, U.S. Patent Application Ser. No. 60/846,575, filed Sep. 22, 2006, entitled “Flavor Application on Edible Substrates” to Wen, et al and U.S. Patent Application Ser. No. 60/846,443, filed Sep. 22, 2006, entitled “Flavor Application on Edible Substrates” to Wen, et al

The combination could be expanded to include registering a flavor to a visual effect of choice, such as color, image and text information. One of the immediate possibilities is to integrate the registered pulsed spray with digital printing technology, enabling the connection of printed information with a registered flavor. The digital printing technology is disclosed in currently pending, commonly assigned, U.S. patent application Ser. No. 10/887,032, filed Jul. 8, 2004, entitled “Image Variety on Edible Substrates” to LuFang Wen, et al.; U.S. patent application Ser. No. 11/201,552, filed Aug. 11, 2005, entitled “Ink Jetting Inks for Food Application” to LuFang Wen, et al.; U.S. patent application Ser. No. 11/410,676, filed Apr. 25, 2006, entitled “Ink Jet Printing of Snacks with High Reliability and Image Quality” to Dechert, et al.; and U.S. patent application Ser. No. 11/398,294, filed Apr. 5, 2006, entitled “Image Registration on Edible Substrates” to Jeffrey W. Martin.

1. Atomization Process

Referring to FIG. 1, since the ultrasonic atomization process does not rely on pressure, the amount of fluid 19 atomized by the vibrating nozzle 14 per unit time is primarily controlled by the fluid delivery system used in conjunction with the vibrating nozzle 14. The flow rate range for vibrating nozzles 14 can be from as low as a few microliters per second to up to about 400 ml/min. Depending on the specific vibrating nozzle 14 and the type of fluid delivery system employed (gear pump, syringe pump, pressurized reservoir, peristaltic pump, gravity feed, etc.), the technology is capable of providing an extraordinary variety of flow/spray possibilities.

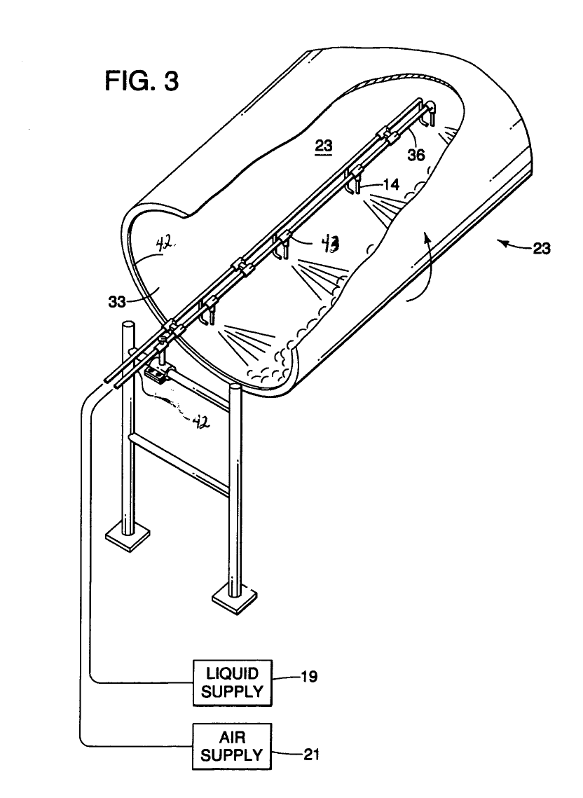

Any suitable fluid flow rate sufficient to reduce the fluid 19 to fine droplets which rain downward in a substrate 11 in a tumbling drum 23 (FIG. 3) or conveyer 26 (FIG. 2) may be used according to the invention. As non-limiting examples, for a single vibrating nozzle 14 fluid flow rates of from about a few microliters per minute to up to about 400 ml/min have been used according to the invention with slurries having viscosities at 110 degree F. of from about 1 centipoise to about 566 centipoise. The vibrating nozzle 14 amplitude may be adjusted to compensate for fluids 19 of various viscosities and/or changes in fluid flow rate. In general, as fluid viscosity and/or fluid flow rate increases, increased vibrating nozzle 14 amplitude is required to reduce the fluid to fine droplets.

In general, the drops produced by ultrasonic atomization have a relatively narrow size distribution. Median drop sizes range from about 18 to about 68 microns, depending on the operating frequency of the specific type of vibrating nozzle 14. As an example, for a vibrating nozzle 14 at 20 kHz with a median drop size diameter of approximately 40 microns, 99.9% of the drops can fall in from about 5 to about 200 micron diameter range.

2. Materials

While a variety of materials and equipment are known and acceptable for these purposes, a power supply and transducer are available from Sonics and Materials, VibroCell 750.

III. Optional Components

Referring to FIG. 2, in an alternative embodiment, the ultrasonic apparatus 10 may optionally include an air instrument 20. An air supply 21 provides a source of compressed air which flows to an air instrument 20. The air instrument 20 can be in the form of a tube (not shown) which can extend into a tumbler drum 23 (FIG. 3) or the converter 13. The air instrument 20 can have a plurality of air outlets, each of which has an opening directed toward the opening of the vibrating nozzle 14 as shown, for example, in FIG. 2. By virtue of the vibrating motion, the fluid 19 exiting from vibrating nozzle 14 is finely atomized and in effect sprayed in the form of a mist or light rain onto the product in the tumbling drum 23 (FIG. 3) or the substrate 11 of the conveyor 26. The air can help to further spread the spray from the vibrating nozzle.

In another alternative embodiment, an amplitude booster could be used to achieve the required amplitude. The amplitude booster can be inserted between the converter 13 and the vibrating nozzle 14. In a non-limiting example, the converter 13 can have a maximum amplitude of 20 μm. To achieve the 180 μm amplitude required, three different designs for converters 13 were used to increase the amplitude from about 20 μm to about 180 μm. In another non-limiting example, the converter 13 serves both as the atomizer and as the amplitude booster to increase the amplitude from about −20 μm to about 180 μm.

Referring to FIG. 3, in another alternative embodiment, a tumbling drum 23 could be used instead of a conveyor 26 (shown in FIG. 2). A hollow cylindrical tumbling drum 23 of the type commonly used in the snack food seasoning art is of conventional shape. The tumbling drum 23 can have a hollow drum open at both ends including an open outlet end 33 and is rotated about its axis by means while positioned with its axis at an angle to a horizontal plane. A small discharge control lip 42 may be provided at the outlet end 33.

As is known in the art, snack food to be seasoned or flavored is fed into an upper end of the drum 23 and as the tumbling drum 23 rotates, the snack food tumbles and moves by gravity down to the lower end where it exits the drum over the lip 42. This is as well known and conventionally practiced in the art.

In accordance with the present invention, the fluid 19 can be connected to a pipe 41 which extends into the drum a predetermined distance. The pipe 41 has positioned along its length a plurality of connectors 43 (all T-connectors except the end L-connector) for connecting a plurality of vibrating nozzles 14. Each nozzle tube 14 has an exit opening 36.

### EXAMPLES

The following are a listing of examples illustrating various embodiments of the present invention. It would be obvious to those skilled in the art that various other changes and modifications can be made without departing from the spirit and scope of the invention.

### Example 1

| Flow properties | | Ultrasonic Setting | |
|---|---|---|---|
| Solid content | 20% | Frequency | 20 kHz |
| Mean Particle | 150 μm | Low power setting | 72 μm |
| Size | | amplitude | |
| Flow rate | 30 g/min | High power setting | 168 μm |
| | | amplitude | |
| Temperature | 60 degree C. | Pulse duration | 5 ms |
| Viscosity | 200 cps | Pulse repetition rate | 1300/min |

### Example 2

| | |
|---|---|
| Flow properties | Ultrasonic Setting |

| | | | |
|---|---|---|---|
| Solid content | 5% | Frequency | 20 kHz |
| Mean Particle | 50 μm | Low power setting | 30 μm |
| Size | | amplitude | |
| Flow rate | 100 g/min | High power setting | 60 μm |
| | | amplitude | |
| Temperature | RT | Pulse duration | 5 ms |
| Viscosity | 90 cps | Pulse repetition rate | 1300/min |

### Example 3

| Flow properties | | Ultrasonic Setting | |
|---|---|---|---|
| Solid content | 5% | Frequency | 19.5-20 kHz |
| Mean Particle | 50 μm | Constant power setting but | 30 μm |
| Size | | moving frequency off | |
| | | resonant to deliver | |
| | | amplitude | |
| Flow rate | 100 g/min | Constant power setting but | 60 μm |
| | | moving the frequency back | |
| | | to resonant frequency to | |
| | | deliver amplitude | |
| Temperature | Rt | Pulse duration | 5 ms |
| Viscosity | 90 cps | Pulse repetition rate | 1300/min |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method to eject a fluid from a surface, comprising the steps of:
a. vibrating a surface of a vibrating nozzle in a direction substantially normal to the surface and
b. providing an amplitude of the vibration that is equal to or greater than about 120 microns.

2. The method of claim 1, wherein the fluid is ejected towards a substrate.

3. The method of claim 2, wherein the substrate is edible.

4. The method of claim 1, wherein the surface is a portion of the surface of said vibrating nozzle.

5. The method of claim 4, wherein the vibrating nozzle is made to vibrate with a transducer, and wherein a power is applied to the transducer, said power operating at a frequency.

6. The method of claim 5, wherein the transducer is selected from the group consisting of a piezoelectric transducer and a magnetostrictive transducer.

7. The method of claim 5, wherein the distance between the transducer and the surface is substantially equal to or a multiple of half of a wavelength of the frequency of the power applied to the transducer.

8. The method of claim 7, wherein the vibrating nozzle is acoustically coupled to the transducer.

9. The method of claim 8, wherein a booster is acoustically coupled between the vibrating nozzle and the transducer.

10. The method of claim 1, wherein said fluid comprises a viscosity modifier.

11. The method of claim 10, wherein said viscosity modifier comprises a material selected from a group consisting of carboxylmethyl cellulose, gums, structurants and mixtures thereof.

12. The method of claim 1, wherein said fluid comprises a surface active material.

13. The method of claim 12, wherein said surface active material comprises a material selected from a group consisting of sodium laurylsulfate, tween80, non-ionic surfactant and monoglyceride, and lecithin.

14. The method of claim 1, wherein said fluid comprises materials selected from a group consisting of oil, glycerides, propylene glycol, water, sucrose polyesters, liquid sugars, glycerin, maltodextrin, alcohol, and mixtures thereof.

15. The method of claim 1, wherein said fluid has a viscosity of about 1 to about 500 cps as said fluid is delivered to said surface.

16. The method of claim 1, wherein the fluid comprises a flavorant.

17. The method of claim 1, wherein said fluid comprises solid particles from about 0 to about 70% by weight.

18. The method of claim 1, wherein the surface is made to vibrate with an amplitude greater than 150 microns.

19. The method of claim 5, wherein the vibrating nozzle shape is designed to amplify the amplitude of the transducer vibration to produce an amplitude of the surface vibration greater than 150 microns.

20. The method of claim 19, wherein the vibrating nozzle shape has a first end near the transducer and a second end comprising the surface, opposite to the first end, and wherein a cross-section of the vibrating nozzle near the second end is smaller than a cross-section of the vibrating nozzle near the first end.
